(19) United States
(12) Patent Application Publication
(10) Pub. No.: US 2025/0323244 A1
(43) Pub. Date: Oct. 16, 2025

(54) PRE-LITHIATED COATED CATHODE ACTIVE MATERIALS, A METHOD OF MAKING SUCH CATHODE ACTIVE MATERIALS, AND BATTERIES INCLUDING SUCH CATHODE ACTIVE MATERIALS

(71) Applicant: GM Global Technology Operations LLC, Detroit, MI (US)

(72) Inventors: Jeffrey David Cain, Royal Oak, MI (US); Sayed Youssef Sayed Nagy, Troy, MI (US); Yuntao Gu, Farmington Hills, MI (US)

(21) Appl. No.: 18/631,500

(22) Filed: Apr. 10, 2024

(51) Int. Cl. H01M 4/36; H01M 4/02; H01M 4/04; H01M 10/0525

(52) U.S. Cl. CPC H01M 4/366; H01M 4/0459; H01M 10/0525; H01M 2004/021; H01M 2004/028

(57) ABSTRACT

A powder includes particles of having a core of cathode active material bearing a coating of an amorphous lithiated material. The powder can be prepared by providing a dispersion of particles having the core and a non-lithiated coating in the presence of a lithium source, applying a voltage or a current across the dispersion or applying a current across a lithiated amorphous region in the coating, and recovering the particles having the lithiated coating in a solid powder form. Batteries including such particles can have good cycling performance.

### INTRODUCTION

The subject disclosure relates to cathode active materials, a method of making cathode active materials, and batteries comprising such cathode active materials.

The subject disclosure relates to a method of forming particles useful in anodes in lithium ion batteries.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”).

Typical lithium-ion batteries include at least two electrodes and an electrolyte and/or separator. One of the two electrodes serves as a positive electrode (a cathode) and the other electrode serves as a negative electrode (an anode). A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand.

More specifically, electrical power can be supplied to a load device by the lithium-ion battery until the lithium content of the negative electrode is effectively depleted. The battery may then be recharged by passing a suitable direct electrical current in the opposite direction between the electrodes.

Cathode active materials can store and release ions, such as lithium ions, during charging and discharging cycles of the battery. Various coatings of materials such as metal oxides, metal phosphates, metal halides, and metal sulfides have been proposed for use on cathode active materials to enhance performance. These coatings are often formed by wet chemical coating processes, such as sol-gel coating or hydro/solvo-thermal coating, atomic layer deposition, or plasma vapor deposition. During cell operation, materials in the cathode can become lithiated (i.e., lithium can be incorporated into such materials). However, with such in-situ formation the lithiated product can be a lithiated organic compound which results in irreversible loss of lithium in formation and cycling. In addition, such in-situ lithiation can reduce initial cycle efficiency and is restricted in the control of formation and composition of the coating composition and morphology.

It would be desirable to have improved coated cathode active materials that provide improved cycling performance and to have an efficient method of producing such coated cathode active materials before assembly of the battery cell.

### SUMMARY

In one exemplary embodiment disclosed is a powder of particles. The particles include a core having a cathode active material, and a lithiated coating on the core. The lithiated coating has a portion having amorphous morphology. The lithiated coating includes a lithiated metal oxide, a lithiated metal halide, a lithiated metal phosphate, or a lithiated sulfur-based material.

In addition the powder can include one or more of the features described herein.

The cathode active material can include lithium cobalt oxides, lithium iron phosphates, lithium nickel manganese cobalt oxides, lithium nickel cobalt aluminum oxides, lithium manganese oxides, or lithium titanates.

The coating can include LiNbO₃, LiTaO₃, LiB₃O₅, LiAlO₂, Li₂SiO₅, Li₂ZrO₃, Li₂TiO₃, LiZnO, Li₂ZnO₃, LiMgO, and Li₂RuO₃, LiMgF₂, LiAlF₃, LiCaF₂, LiYF₃, LiLaF₃, LiFePO₄, LiAlPO₄, and LiCo₃(PO₄)₂, or Li₂S.

The particles can have an average particle size of 0.1 to 20 micrometers.

The coating can be from 0.2 to 2 mass percent of the particles based on total mass of the particles.

The coating can be entirely amorphous.

The coating can include an interior region which is not lithiated. For example, the interior region can include a non-lithiated metal oxide, a non-lithiated metal halide, a non-lithiated metal phosphate, or a non-lithiated sulfur-based material.

The coating includes an inner region having a first composition and an outer region having a second composition that is different from the first composition. The first composition can include a non-lithiated metal oxide, a lithiated metal oxide, a non-lithiated metal phosphate, a lithiated metal phosphate, a non-lithiated metal halide, a lithiated metal halide, a non-lithiated sulfur-based material, a lithiated sulfur-based material, a carbon material, or a polymer. The second composition can include a lithiated metal oxide, a lithiated metal halide, a lithiated metal phosphate, or a lithiated sulfur-based material.

In another exemplary embodiment disclosed is a lithium ion battery having an anode disposed on an anode current collector, a cathode disposed on a cathode current collector, and an electrolyte. Optionally a separator is disposed between the anode and the cathode. The anode includes anode active materials, and, optionally, an anode binder, electrically conductive material, or both the anode binder and the electrically conductive material. The cathode includes particles of coated cathode active material, and, optionally, a cathode binder, electrically conductive material, or both the cathode binder and the electrically conductive material. The particles of coated cathode active material comprise a core of cathode active material and a pre-formed coating on the core, wherein the pre-formed coating comprises a lithiated metal oxide, a lithiated metal halide, a lithiated metal phosphate, or a lithiated sulfur-based material wherein a portion of the pre-formed coating has amorphous morphology.

In addition the battery can include one or more of the features described herein.

The pre-formed coating can have a composition that could not be formed in situ in the lithium ion battery. For example, the pre-formed coating can include a residue of fluoroethylene carbonate, vinylene carbonate, tetraethoxysilane, (2-cyanoethyl)triethoxysilane, dimethylacrylamide, methyl (2,2,2-trifluoroethyl) carbonate, fluorinated phosphate, fluoroacetate, fluoronitrile, fluorinated phosphazene, fluoroborate, fluoroborane, fluorinated phosphite, or fluorosultone.

The lithium ion battery is made by forming the anode by applying a coating comprising anode active materials and binder on the anode current collector, forming the cathode by providing a coating of the cathode active materials comprising the pre-formed coating and a binder on the cathode current collector, and assembling the anode, the cathode, the optional separator and the battery electrolyte to form the lithium ion battery.

In another exemplary embodiment disclosed is a method including first providing a dispersion in the presence of a lithium source. The dispersion includes particles in a liquid electrolyte solution. The particles include a core including a cathode active material, and a coating on the core. The coating includes non-lithiated metal oxide, non-lithiated sulfur-based material, non-lithiated metal phosphate, or non-lithiated metal halide. The coating is lithiated by applying a voltage across the dispersion or applying a current across the dispersion to form a lithiated amorphous region in the coating. After lithiation, the particles having the lithiated coating are recovered in solid powder form.

In addition the method can include one or more of the features described herein.

The lithium source can provide a stoichiometric excess of lithium to form a stable form of a lithiated metal oxide, a lithiated sulfur-based material, a lithiated metal halide, or a lithiated metal phosphate.

The voltage can be applied at a level of 1-5 volts.

The voltage can be held constant.

The current can be held constant.

The coating on the particles can be fully lithiated to a stable form of a lithiated metal oxide, a lithiated sulfur-based material, a lithiated metal halide, or a lithiated metal phosphate.

A portion of the coating on the particles can remain unlithiated.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic of an example of a coated cathode active material particle as can be made by an example of the method disclosed herein with a pre-lithiated coating;

FIG. 2 is a schematic of an example of a device for performing certain embodiments of the method as disclosed herein; and

FIG. 3 is a schematic of an example electrochemical lithium ion battery.

### DETAILED DESCRIPTION

The following description is merely exemplary in nature and is not intended to limit the present disclosure, its application or uses. It should be understood that throughout the drawings, corresponding reference numerals indicate like or corresponding parts and features.

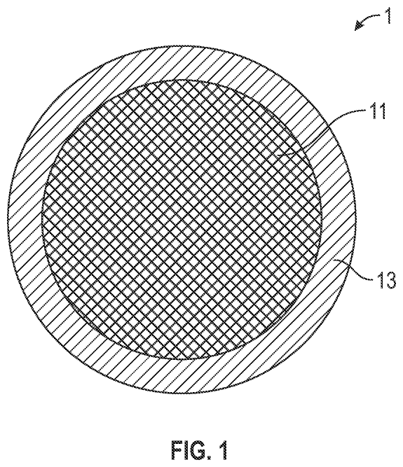

In accordance with an exemplary embodiment the powder as disclosed herein includes particles 1, having a core 11 and a coating 13 as shown in FIG. 1. The coating 13 is lithiated (i.e., has lithium incorporated therein). The core 11 includes a cathode active material. Examples of cathode active materials include lithium cobalt oxides, lithium iron phosphates, lithium nickel manganese cobalt oxides, lithium nickel cobalt aluminum oxides, lithium manganese oxides, and lithium titanates. Additional examples of cathode active materials include lithium-based positive electroactive materials selected from LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where M is one of Mn, Ni, Co, and Al and 0≤x≤1) (for example LiCoO₂ (LCO), LiNiO₂, LiMnO₂, LiNi_{0.5}Mn_{0.5}O₂, NMC111, NMC523, NMC622, NMC 721, NMC811, NCA), LiMn₂O₄ and LiNi_{0.5}Mn_{1.5}O₄, LiV₂(PO₄)₃, LiFePO₄, LiCoPO₄, LiMnPO₄, LiVPO₄F, LiFeBO₃, LiCoBO₃, LiMnBO₃, Li₂FeSiO₄, Li₂MnSiO₄, and LiMnSiO₄F. The cathode active material may be doped, for example by one or more of magnesium, aluminum, or manganese.

The coating 13 includes a lithiated metal oxide, a lithiated metal phosphate, a lithiated metal halide, or a lithiated sulfur-based compound.

Examples lithiated metal oxides include lithiated magnesium oxides, lithiated boron oxides, lithiated niobium oxides, lithium tantalum oxides, lithiated aluminum oxides, lithiated silicon oxides, lithiated zinc oxides, lithiated zirconium oxides, lithiated cesium oxides, lithiated titanium oxides, and lithiated ruthenium oxides. Specific examples of lithiated metal oxides in a stable form include LiNbO₃, LiTaO₃, LiB₃O₅, LiAlO₂, Li₂SiO₅, Li₂ZrO₃, Li₂TiO₃, LiZnO, Li₂ZnO₃, LiMgO, and Li₂RuO₃.

Examples of lithiated metal halides include metal fluorides, such as lithiated magnesium fluoride, lithiated aluminum fluoride, lithiated calcium fluoride, lithiated yttrium fluoride, and lithiated lanthanum fluoride. Specific examples of lithiated metal halides in a stable form include LiMgF₂, LiAlF₃, LiCaF₂, LiYF₃, LiLaF₃.

Examples of lithiated metal phosphates include lithiated iron phosphates, lithiated aluminum phosphates, and lithiated cobalt phosphates. Specific examples of lithiated metal phosphates in a stable form include LiFePO₄, LiAlPO₄, and LiCo₃(PO₄)₂.

Examples of lithiated sulfur-based compounds include lithiated sulfur, which can be Li₂S in a stable form.

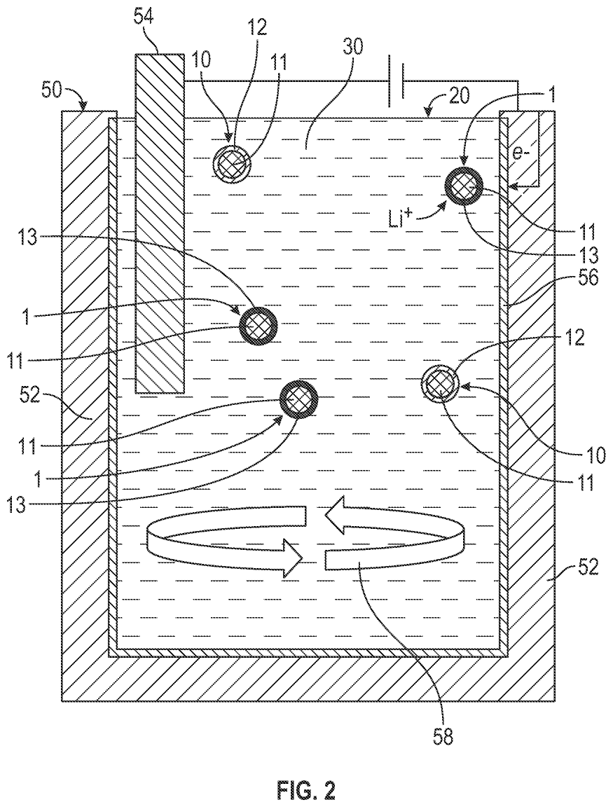

Optionally, the coating 13 can include an inner region of a first composition and an outer region of a second composition different from the first composition. The outer layer region includes the lithiated metal oxide, the lithiated metal phosphate, the lithiated metal halide, or the lithiated sulfur-based compound as described above. The inner layer region can include a metal oxide (without lithium), a lithiated metal oxide, a metal phosphate (without lithium), a lithiated metal phosphate, a metal halide (without lithium), a lithiated metal halide, a sulfur-based material (without lithium), a lithiated sulfur-based compound, carbon materials, or polymers. For example, the inner layer region can include a non-lithiated metal oxide, a non-lithiated metal halide, a non-lithiated sulfur-based compound, or a non-lithiated metal phosphate that differs from the outer layer region when a coating 12 (which is not lithiated) of a precursor particle 10 as shown in FIG. 2 is not fully lithiated through the whole depth of the coating 12.

The coating 13 can be formed by pre-lithiation according to the process as disclosed herein. The process enables control of the amount or degree of lithiation. For example, the process can provide lithiation up to a stable lithiated form of the metal oxide, the metal phosphate, the metal halide, or the sulfur-based material.

The coating 13 includes amorphous morphology. The amorphous morphology can be detected or confirmed using transmission electron microscopy. The coating 13 can be an entirely amorphous coating if full lithiation of the coating 12 of the precursor particles 10 has occurred according to the process as shown in FIG. 2. By full lithiation as used herein we mean the entire coating 12 of a metal oxide, a sulfur-based material, a metal halide, or a metal phosphate of the precursor particles 10 has been lithiated to a stable lithiated form. Alternatively, if less than full lithiation has occurred only a portion of the coating 13 may be lithiated and thus, the entire coating 13 may not be amorphous. Rather in this instance, it is possible for a portion of the coating 13 to retain its original morphology which can be a crystalline morphology. For example, an inner layer region of the coating 13 may remain as a metal oxide, a sulfur-based material, a metal halide, or a metal phosphate. As another example, if less than full lithiation has occurred, some of particles 1 in the powder may have a coating 13 that is fully lithiated which other particles 1 in the powder include particles 1 which have a coating 13 that are partially lithiated and which, therefore, may be partially amorphous. The coating 13 can be, for example, at least 50, at least 60, at least 70, at least 80, at least 90, at least 95, at least 99, or 100 volume % amorphous based on total volume of the coating 13, as determined by inspection using transmission electron microscopy. As another example, if the particles are not fully lithiated powder could include a mixture of pre-lithiated particles 1 and precursor particles 10 that have not been lithiated but rather comprise a coating of a metal oxide, a sulfur-based material, a metal halide, or a metal phosphate.

The particles 1 can have an average particle size of, for example, from 0.1, from 0.5, or from 1 micron up to 20, up to 15, or up 10 micrometers (m), up to as measured by dynamic light scattering, scanning electron microscopy, or transmission electron microscopy. The particles 1 may include a core 11 that is a single structure or is an agglomerated structure. The particles can have, for example, a substantially spherical shape, an irregular shape or a platelet shape. The lithiated coating 13 can have a thickness of 10 nm to 500 nm as measured by scanning electron microscopy or transmission electron microscopy. The coating 13 can be from 0.2, from 0.3, from 0.4, or from 0.5 up to 2, up to 1.75, up to 1.5, up to 1.25, or up to 1 mass percent based on total mass of the particles 1.

In addition to lithiation of the coating to form coating 13, other components can be imbibed into the coating during the process. Such other components could include species not found in the battery in which the pre-lithiated coated cathode active particles are used. Examples of such additional species include fluoroethylene carbonate (FEC), vinylene carbonate (VC), tetraethoxysilane (TEOS), (2-cyanoethyl)triethoxysilane (TEOSCN), dimethylacrylamide (DMAA), methyl (2,2,2-trifluoroethyl) carbonate (FEMC), fluorinated phosphate, fluoroacetate, fluoronitrile, fluorinated phosphazene, fluoroborate, fluoroborane, fluorinated phosphite, and fluorosultone.

Referring to FIG. 2 as an exemplary embodiment, the method as disclosed herein includes providing a dispersion 20 of coated precursor particles 10 and electrolyte solution 30 in a vessel 50 in the presence of a lithium source.

The coated precursor particles 10 include a core 11 as described above and a coating 12 which is not lithiated. The coating 12 can be a metal oxide, a metal phosphate, a metal halide, or a sulfur-based compound, each of which do not include lithium. Examples of such metal oxides include niobium oxides (e.g., Nb₂O₅), tantalum oxides (e.g., Ta₂O₅), boron oxides (e.g., B₂O₃), magnesium oxides (e.g., MgO), aluminum oxides (e.g., Al₂O₃), silicon oxides (e.g., SiO₂), zinc oxides (e.g., ZnO), zirconium oxides (e.g., ZrO₂), cesium oxides (e.g., CeO₂), titanium oxides (e.g., TiO₂), and ruthenium oxides (e.g., RuO₂). Examples of such metal halides include particularly fluorides, such as magnesium fluoride (e.g., MgF₂), aluminum fluoride (e.g., AlF₃), calcium fluoride (e.g., CaF₂), yttrium fluoride (e.g., YF₃), and lanthanum fluoride (e.g., LaF₃). Examples of such metal phosphates include iron phosphates (e.g., FePO₄), aluminum phosphates (e.g., AlPO₄), and cobalt phosphates (e.g., Co₃(PO₄)₂). Examples of sulfur based materials include sulfur (S).

The electrolyte solution 30 can have an ionic compound, such as a salt, in a solvent. Examples of such ionic compounds that can be used include lithium bis(fluorosulfonyl)imide, lithium bis(trifluoromethanesulfonyl)imide, lithium bis(oxalato)borate, lithium difluorooxalatoborate, and 1,1,2,2-tetra-fluoroethyl-2,2,3,3-tetrafluoropropyl ether. Examples of the solvent include ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, and tetraethylene glycol dimethyl ether.

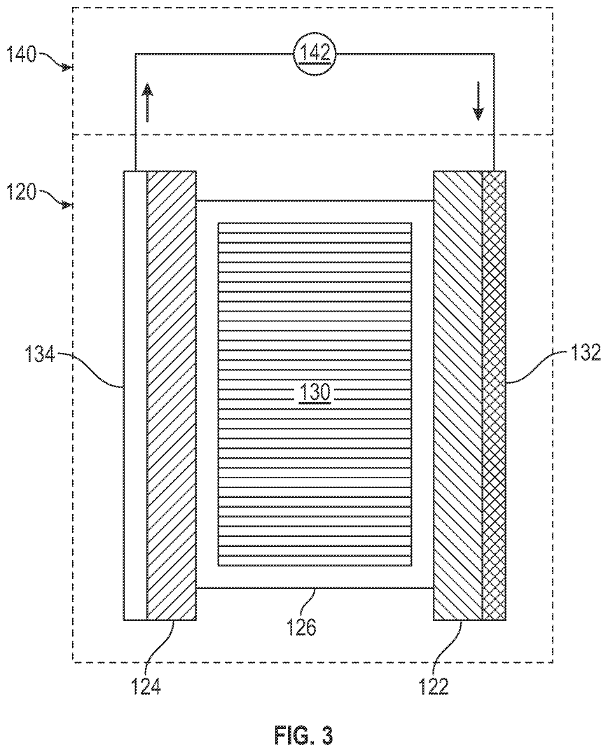

The vessel can include a shell 52. The shell 52 can include conductive material 56 which contacts the dispersion 20 and which can serve as a current collector. An electrode 54, which can optionally include lithium an alloy including lithium and serve as the lithium source, such as a can be placed in the electrolyte solution 30. Another option of a lithium source can be, for example, lithium titanate or lithiated graphite. When a voltage or current is applied from the electrode 54 to the conductive material 56, particles 10 having a core 11 and an unlithiated coating 12 that contact the conductive material 56 are lithiated to form particles 1 having a core 11 and a coating 13 which is lithiated. An additive component can optionally be included in the electrolyte solution 30. For example, the additive can be a component that is soluble in the electrolyte solution 30 or can be a component that is dispersed in the electrolyte solution 30. The additive can include chemical components not found in a battery (including an electrolyte 130 of a battery) such as the battery 120 of FIG. 3.

The vessel can include a mixer 58. As an alternative to the vessel 50 as shown which can operate in batch mode, a flow-through vessel (not shown) could be used for continuous production.

When the method is undertaken potentiostatically, a voltage is applied to lithiate and form coating 13. The voltage can be selected to provide the desired amount of lithiation of the coating. The voltage, can be for example, from about 1 to about 5 volts. With sufficient time to reach equilibrium, the coating 12 on the precursor particles 10 will be fully to the degree obtainable using that voltage, provided an excess of lithium from the lithium source is available. At different voltages a different degree of lithiation is achieved. Using voltages of less than 1 can be undesirable as that could extract lithium from the core 11 comprising the cathode active material. The voltage can be applied for a time sufficient to ensure at least 50%, at least 70%, at least 90%, at least 95%, at least 98%, or at least 99% of the particles 10 contact the conductive material 56 and are lithiated. The time required may decrease with increase effective agitation or mixing of the dispersion 20.

When the method is undertaken galvanostatically, a constant current is applied to lithiate the coating 12 to form the coating 13. One may control the rate of current and the time to control the amount of lithiation provided an excess of lithium from the lithium source is available.

In the event that the amount of lithium from the lithium source is less than the stoichiometric amount needed to achieve a stable form of the lithiated metal oxide, lithiated metal phosphate, lithiated metal halide or lithiated sulfur-based material, full lithiation is not attainable. Limiting the lithium available can be used to achieve less than full lithiation if that is desired.

The dispersion 20 can include the particles 1 and 10 in a combined amount of from 1 to 25, or 1.5 to 20, or 2 to 10, weight percent based on total weight of the dispersion. The dispersion 20 can include the optional additive in the electrolyte solution 30 in an amount of from 0 or from 0.001 to 10, or 0.01 to 5, or 0.1 to 3 weight percent based on total weight of the dispersion. The electrolyte solution 30 can make up the remainder of the dispersion 20.

After forming the coated particles, the coated particles 1 can be separated from the dispersion 20 for future use. For example, the dispersion 20 can be filtered to separate the lithiated coated particles 1 from the electrolyte solution 30. Optionally, the lithiated coated particles 1 can be rinsed. As another example, a centrifuge can be used to separate the lithiated coated particles 1.

FIG. 3 shows an exemplary schematic illustration of an electrochemical cell (also referred to as the battery) 120. The battery 120 includes a negative electrode (i.e., anode) 122 disposed on a current collector 132, a positive electrode (i.e., cathode) 124 disposed on a current collector 134, and a separator 126 disposed between the electrodes 122, 124. The separator 126 provides electrical separation (i.e., prevents physical contact) between the electrodes 122, 124. The separator 126 also provides a minimal resistance path for internal passage of lithium ions, and in certain instances, related anions, during cycling of the lithium ions. The battery includes electrolyte 130 shown as present in the separator 126. In certain aspects, the electrolyte can also be present in the anode 122 and cathode 124. In certain variations, the separator 126 may be formed by a solid-state electrolyte 130. The anode current collector 132 and the cathode current collector 134 respectively collect and move free electrons to and from an external circuit 140. For example, an interruptible external circuit 140 and a load device 142 may connect the anode 122 (through the negative electrode current collector 132) and the cathode 124 (through the cathode current collector 134).

The cathode 124 includes the particles 1 which may be optionally intermingled with one or more electrically conductive materials that provide an electron conductive path and/or at least one polymeric binder material that improves the structural integrity of the cathode 124. Examples of binders include poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Examples of electrically conductive materials include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the cathode 124 may include greater than or equal to about 50 wt. % to less than or equal to about 99 wt. %, and in certain aspects, optionally greater than or equal to about 50 wt. % to less than or equal to about 95 wt. %, of the particles 1; greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more binders.

In the battery 120, the anode 122 can include an active material such as carbon based materials such as graphite, silicon-based materials such as LixSi, SiOx, LiSiOx, nano-Si, lithium titanates, or metal alloys such as alloys of two or more of tin, germanium, and cobalt. The anode active material can include a pre-formed solid electrolyte interface.

The anode 122 can further include electrically conductive material such as carbon black, graphene, and/or carbon nanotubes. The anode 122 can further include a binder material such as binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof.

The anode 122 can include, for example, greater than or equal to about 0 wt. % to less than or equal to about 20 wt. %, and in certain aspects, optionally greater than or equal to about 5 wt. % to less than or equal to about 15 wt. % of one or more binders.

The battery electrolyte 130 can include an ionic compound, such as a salt, optionally, in a solvent. Examples of such ionic compounds that can be used include lithium bis(fluorosulfonyl)imide, lithium bis(trifluoromethanesulfonyl)imide, lithium bis(oxalato)borate, lithium difluorooxalatoborate, and 1,1,2,2-tetra-fluoroethyl-2,2,3,3-tetrafluoropropyl ether. Examples of the solvent include ethylene carbonate, dimethyl carbonate, ethyl methyl carbonate, diethyl carbonate, propylene carbonate, dimethyl sulfoxide, ethyl acetate, gamma butyrolactone, 1,2-dimethoxyethane, and tetraethylene glycol dimethyl ether.

In an exemplary embodiment, the battery can have a solid state polymer electrolyte.

The separator 126 can include polymeric separators, such as polypropylene or polyethylene, ceramics, or polymer/ceramic composites.

In an exemplary embodiment, the battery can have a solid state electrolyte/separator such as ceramic, e.g., a lithium metal oxide, LISICON, pervoskites, sulfide solid electrolyte, or garnets.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A powder comprising particles wherein the particles comprise:
a core comprising a cathode active material,
a coating on the core wherein the coating comprises a lithiated metal oxide, a lithiated metal halide, a lithiated metal phosphate, or a lithiated sulfur-based material wherein a portion of the coating has an amorphous morphology.

2. The powder of claim 1 wherein the cathode active material is selected from lithium cobalt oxides, lithium iron phosphates, lithium nickel manganese cobalt oxides, lithium nickel cobalt aluminum oxides, lithium manganese oxides, and lithium titanates.

3. The powder of claim 1 wherein the coating comprises LiNbO₃, LiTaO₃, LiB₃O₅, LiAlO₂, Li₂SiO₅, Li₂ZrO₃, Li₂TiO₃, LiZnO, Li₂ZnO₃, LiMgO, and Li₂RuO₃, LiMgF₂, LiAlF₃, LiCaF₂, LiYF₃, LiLaF₃, LiFePO₄, LiAlPO₄, and LiCo₃(PO₄)₂, or Li₂S.

4. The powder of claim 1 wherein the particles have an average particle size of 0.1 to 20 micrometers.

5. The powder of claim 1 wherein the coating comprises 0.2 to 2 mass percent of the particles based on total mass of the particles.

6. The powder of claim 1 wherein the coating is entirely amorphous.

7. The powder of claim 1 wherein an interior region of the coating is not lithiated.

8. The powder of claim 7 wherein the interior region comprises comprises a non-lithiated metal oxide, a non-lithiated metal halide, a non-lithiated metal phosphate, or a non-lithiated sulfur-based material.

9. The powder of claim 1 wherein the coating includes an inner region having a first composition and an outer region having a second composition that is different from the first composition, the inner region comprising non-lithiated metal oxide, a lithiated metal oxide, a non-lithiated metal phosphate, a lithiated metal phosphate, a non-lithiated metal halide, a lithiated metal halide, a non-lithiated sulfur-based material, a lithiated sulfur-based material, a carbon material, or a polymer, and the outer region comprising a lithiated metal oxide, a lithiated metal halide, a lithiated metal phosphate, or a lithiated sulfur-based material.

10. A lithium ion battery comprising:
an anode disposed on an anode current collector, the anode comprising anode active materials, and, optionally, an anode binder, electrically conductive material, or both the anode binder and the electrically conductive material,
a cathode disposed on a cathode current collector, the cathode comprising particles of coated cathode active material, and, optionally, a cathode binder, electrically conductive material, or both the cathode binder and the electrically conductive material,
an optional separator, disposed between the anode and the cathode, and
a battery electrolyte,
wherein the particles of coated cathode active material comprise a core of cathode active material and a pre-formed coating on the core, wherein the pre-formed coating comprises a lithiated metal oxide, a lithiated metal halide, a lithiated metal phosphate, or a lithiated sulfur-based material wherein a portion of the pre-formed coating has amorphous morphology.

11. The lithium ion battery of claim 10 wherein the pre-formed coating has a composition that could not be formed in situ in the lithium ion battery.

12. The lithium ion battery of claim 11 wherein the pre-formed coating further comprises a residue of fluoroethylene carbonate, vinylene carbonate, tetraethoxysilane, (2-cyanoethyl)triethoxysilane, dimethylacrylamide, methyl (2,2,2-trifluoroethyl) carbonate, fluorinated phosphate, fluoroacetate, fluoronitrile, fluorinated phosphazene, fluoroborate, fluoroborane, fluorinated phosphite, or fluorosultone.

13. The lithium ion battery of claim 10 made by forming the anode by applying a coating comprising anode active materials and binder on the anode current collector, forming the cathode by providing a coating of the cathode active materials comprising the pre-formed coating and a binder on the cathode current collector, and assembling the anode, the cathode, the optional separator and the electrolyte to form the lithium ion battery.

14. A method comprising:
providing a dispersion in the presence of a lithium source in a vessel configured for electrochemical reactions, wherein the dispersion comprises particles and a liquid electrolyte solution, wherein the particles comprise a core comprising a cathode active material, and a coating on the core wherein the coating comprises non-lithiated metal oxide, non-lithiated sulfur-based material, non-lithiated metal phosphate, or non-lithiated metal halide,
lithiating the coating by applying a voltage across the dispersion or applying a current across the dispersion to form a lithiated amorphous region in the coating, and
recovering the particles having the lithiated coating in a solid powder form.

15. The method of claim 14 wherein the lithium source provides a stoichiometric excess of lithium to form a stable form of a lithiated metal oxide, a lithiated sulfur-based material, a lithiated metal halide, or a lithiated metal phosphate.

16. The method of claim 14 wherein the voltage is applied at a level of 1-5 volts.

17. The method of claim 14 wherein the voltage is held constant.

18. The method of claim 14 wherein the current is held constant.

19. The method of claim 14 wherein the coating on the particles is fully lithiated to a stable form of a lithiated metal oxide, a lithiated sulfur-based material, a lithiated metal halide, or a lithiated metal phosphate.

20. The method of claim 14 wherein a portion of the coating on the particles remains unlithiated.
